(19) United States
(12) Patent Application Publication
(10) Pub. No.: US 2016/0356198 A1
(43) Pub. Date: Dec. 8, 2016

(54) MODULAR SYSTEM FOR AMMONIA STORAGE

(71) Applicant: AAQIUS & AAQIUS SA, Geneva (CH)

(72) Inventor: Jean-Baptiste DEMENTHON, Paris (FR)

(73) Assignee: AAQIUS & AAQIUS SA, Geneva (CH)

(21) Appl. No.: 15/106,098

(22) PCT Filed: Dec. 19, 2014
(86) PCT No.: PCT/EP2014/078649

§ 371 Date: Jun. 17, 2016

(30) Foreign Application Priority Data
Dec. 20, 2013 (FR) 1363320

(51) Int. Cl. F01N 3/28; F01N 3/20; B01D 53/94; F17C 11/00; C01C 1/00; B01J 20/04

(52) U.S. Cl. CPC F01N 3/28; C01C 1/006; B01J 20/046; B01D 53/9431; F17C 11/00; F01N 3/2066; B01D 2251/2062; B01D 2258/012; F01N 2610/02

(57) ABSTRACT

A construction module of a structure is provided for ammonia storage, the structure including at least one layer of salt suitable for an adsorbing or absorbing ammonia, the module including an attachment for attaching the module to at least one other module. The disclosure also relates to a storage of gases in solids.

### CROSS-REFERENCE TO RELATED APPLICATIONS

This application is a National Phase Entry of International Patent Application No. PCT/EP2014/078649, filed on Dec. 19, 2014, which claims priority to French Patent Application Serial No. 1363320, filed on Dec. 20, 2013, both of which are incorporated by reference herein.

### TECHNICAL FIELD

The invention relates generally to storage of gases in solids.

### BACKGROUND

The storage of gases in solids generally makes it possible to store a gas at storage pressures less than those encountered in the case of purely gaseous storage. Applications of this type of storage are diverse and relate for example to the use of hydrogen in a fuel battery intended for the production of electricity, or the use of ammonia in applications for reduction of nitrogen oxides NOx by selective catalytic reduction (SCR), particularly for reducing emissions of pollutants by internal combustion engines, particularly diesel engines. The applicant has thus proposed storage structures (or cartridges) intended to be carried on board automotive vehicles, and capable of freeing a flow of ammonia depending on the power setting of the vehicle motor, so as to mix the ammonia with the exhaust gases of the engine and proceed with an SCR reaction.

More precisely, the applicant has proposed cartridges wherein the ammonia storage material, comprising a salt capable of adsorbing or absorbing ammonia, is in the form of coherent wafers (that is, the salt is not in a loose condition). The wafers are separated by segments of a heat conducting material such as graphite. The layers of salt and graphite are alternated to form a stack of coherent (or solid) layers, positioned inside the cartridge.

One problem that arises in the perspective of equipping different vehicles is based on the fact that the shapes and dimensions of the cartridges carried aboard different vehicles are likely to vary to a considerable degree. In fact these shapes and dimensions will be conditioned, case by case, by considerations such as the desired dimensions for the cartridge, placement constraints in the vehicle, and the fact that the cartridges must resist internal pressures of several bars.

One solution would then be to manufacture “tailor-made” layers of salt and graphite, to adjust their shapes and dimensions to those of the interior of the cartridge that must receive them. But this would require a design effort for each type of vehicle. And from an operational standpoint, the multiplication of shapes and dimensions of layers would bring about complex logistics.

### SUMMARY

The invention aims to dispense with these constraints. In order to attain this goal, the invention proposes a module for constructing an ammonia storage structure, said structure comprising at least one layer of salt capable of adsorbing or absorbing ammonia, said module comprising attachment means to be attached to at least one other module. Thus only one single type of element is needed, or a small number of different types of elements with standardized shapes, for achieving layers and storage structures of highly variable shapes and dimensions. This standardization makes possible in particular economies of scale and simplicity in implementation of the associated methods.

The invention is advantageously supplemented by the following features, taken alone or in any one of their technically possible combinations:
the module comprises a part made of salt capable of adsorbing or absorbing ammonia,
the structure comprises an alternation of layers of salt capable of adsorbing or absorbing ammonia and of layers of heat conducting material,
the module comprises a part made of said heat conducting material,
the attachment means comprise at least one element forming a protrusion from a first surface of the module and capable of piercing a surface of the other module,
the at least one protruding element is formed by at least one stem attached by insertion through the first surface of the module,
a base having the at least one stem,
the attachment means comprise a part of a first surface of the module, the shape whereof is complementary to a part of a second surface of the module.

The invention also relates to an assembly of at least one module as described previously and of at least one other module as described previously, the at least one module and the at least one other module being assembled by the attachment means of at least one of the modules. The invention also relates to an ammonia storage structure comprising at least one layer of salt capable of adsorbing or absorbing ammonia, comprising an assembly as described previously. The invention also relates to a system for storing gas by absorption or adsorption, comprising an enclosure in which is positioned a storage structure as described previously. The invention also relates to a system for selective catalytic reduction for exhaust gases of internal combustion engines, comprising a storage system as described previously and a module for injecting ammonia into the exhaust gases. Finally, the invention relates to a manufacturing method for a structure as described previously, comprising the assembly of a module as described previously, using the attachment means of this module, to another module as described previously.

### BRIEF DESCRIPTION OF THE DRAWINGS

Other features, aims and advantages of the invention will appear during the description hereafter of embodiments. In the appended drawings:

FIG. 1 shows a construction module according to one embodiment of the invention;

FIG. 2 shows a construction module according to another embodiment of the invention;

FIG. 3 shows construction modules according to yet another embodiment of the invention;

FIGS. 4a and 4b show perspective views of two opposite faces of the module of FIG. 2;

FIG. 5 shows construction modules according to yet another embodiment of the invention;

FIG. 6 shows a construction module according to yet another embodiment of the invention;

FIG. 7 shows a system for storing gas according to one embodiment of the invention; and

FIG. 8 shows a selective catalytic reduction system according to one embodiment of the invention.

### DETAILED DESCRIPTION

### Construction Module

With reference to the figures, a module 10 for constructing an ammonia storage structure 100 is described. The structure 100 comprises at least one layer of salt capable of adsorbing or absorbing ammonia. The module 10 comprises attachment means to attach it to at least one other module.

It is thus possible to easily assemble such modules to create the storage structure. Thus there is a need for a single type of element or a small number of different types of element with standardized shapes for creating layers and storage structures with highly variable shapes and dimensions. This standardization particularly allows economies of scale and simplicity of implementation of the associated methods.

Moreover, it is thus possible to easily achieve storage structures and to arrange them without difficulty in the enclosure, the attachment means providing for holding the modules forming the storage structure. In addition, it is thus possible to achieve a structure the modules whereof are integral with one another, which allows great robustness in the structure, and which makes it possible in particular to transport the structure risk-free outside of an enclosure. It is possible to achieve a module comprising attachment means on a plurality of faces so as to allow assembly in several directions, for example a vertical assembly and a horizontal assembly.

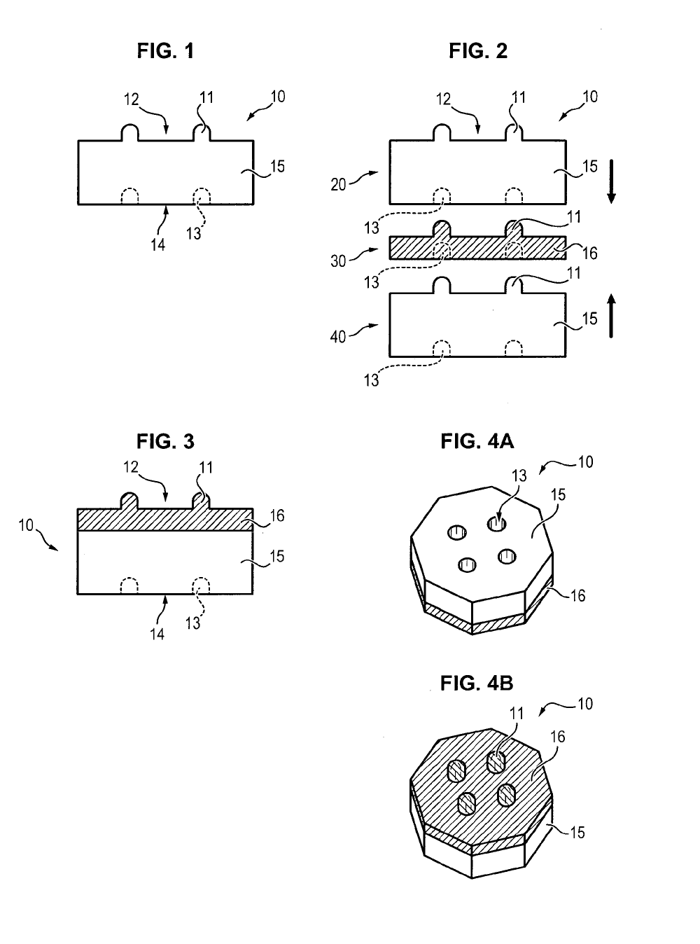

With reference to FIG. 1, the attachment means comprise for example a part 11 of a first surface 12 of the module 10, the shape whereof is complementary to a part 13 of a second surface 14 of the module 10. This part 11 of the first surface 12 is for example protruding, the part 13 of the second surface then forming a hollow area suited to accommodate the protrusion so as to maintain two modules in contact. The protrusion can have dimensions slightly greater than the hollow area so as to allow forced fitting.

The module 10 can comprise a part made of salt 15 capable of adsorbing or absorbing ammonia. Alternatively or as a supplement, the module 10 can comprise a part made of said heat conducting material 16. As illustrated in FIG. 1, the module can consist of salt 15. Alternatively, the module 10 can consist of thermally conductive material 16. With reference to FIG. 2, it is thus possible to assemble a module 30 consisting of the thermally conducting material between two modules 20 and 40 each consisting of salt 15. It is thus possible to easily obtain a structure comprising an alternation of layers.

With reference to FIGS. 3, 4a and 4b, the module 10 can comprise a part made of salt 15 capable of adsorbing or absorbing ammonia, and a part made of said heat conducting material 16. Such a module 10 makes it possible to easily achieve a dual-layer structure having an alternation of layers of salt capable of adsorbing or absorbing ammonia and of layers of heat conducting material. The part made of salt 15 capable of adsorbing or absorbing ammonia and the part made of said heat conducting material 16 are for example superimposed one on the other in the module 10.

The first surface is for example a surface of the part made of salt 15 and the second surface is for example a surface of the part made of said heat conducting material 16. Thus, the part 11 of the first surface 12 of the module 10 is for example formed at the part made of salt 15, and the part 13 of the second surface 14 of the module 10 is for example formed at the part made of said heat conducting material 16, so that during assembly, the part made of salt 15 is attached to a part made of said heat conducting material 16 of another module.

The module 10 can have different types of general shapes allowing assembly. The module 10 can have a generally cylindrical shape of revolution so as to allow easy stacking. Alternatively, the module 10 can have a general shape of a cylinder with a polygonal base, for example with a regular polygonal base, so as to be able to be assembled laterally with other modules of the same shape so as to form a checkerboard pattern. It is therefore possible to select a suitable module shape for achieving by assembly structures of different shapes and with different arrangements of layers.

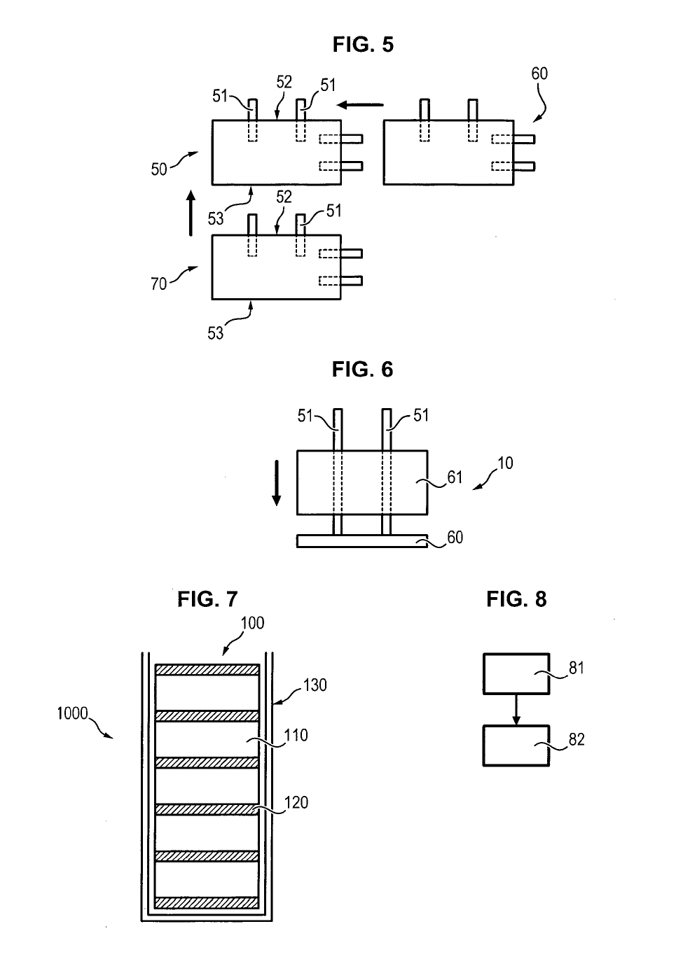

With reference to FIG. 5, the attachment means can comprise at least one element forming a protrusion 51 from a first surface 52 of the module 50. The attachment means can for example comprise a plurality of such elements forming a protrusion 51. The at least one element forming a protrusion 51 is for example able to pierce a second surface 53 of the at least one other module 60 so as to attach the two modules to one another.

It is thus possible to provide attachment means on only one surface of the module 50 and not on the complementary surface of the other module 60, the latter later being pierced. It is thus possible to achieve economies of scale. Moreover, such an attachment between modules makes it possible to ensure the continuity of the assembly, in particular when the pierced surface is made of salt which lends itself to this assembly by piercing. The at least one element forming a protrusion 51 is for example formed by at least one stem attached by insertion through the first surface 52 of the module. Thus the module can easily be made by fixing the stems to a block made of at least one material constituting the structure to be created, so as to form the module.

The first surface 52 is for example a surface of a part made of salt and/or made of said heat conducting material of the module 50. Thus the module can be easily made by attaching the stems to a block comprising or constituted of the salt or of said heat conducting material, for example to a part made of salt capable of adsorbing or absorbing ammonia or to a part made of said heat conducting material.

It is easy to create a module 20 comprising such elements forming protrusions over several surfaces of the module 20. In particular, it is thus possible to easily create a module 20 allowing assembly in several directions, for example vertical assembly between the module 50 and a module 70, and horizontal assembly between the module 50 and a module 60. The stem(s) typically comprise(s) a portion forming a protrusion outside the module, and a portion inserted by piercing inside a block made of at least one material constituting the structure to be assembled. Preferentially, the stem(s) extend(s) between an end positioned outside the module and an end positioned inside a block of at least one material constituting the structure to be assembled.

Referring to FIG. 6, the module 10 can comprise a base 60 having the at least one stem, several stems for example, extending from the base. This base 60 forms for example a base from which a block 61, consisting of or comprising a part made of salt or of said heat conducting material can be pierced by the stem, preferentially all the way through, so as to form a module, the parts of the stem having pierced the block and extending outside the block while forming a protrusion constituting the means for attaching the module to another module. Several blocks can thus be pierced through by the stems.

It is thus possible to easily form a structure to be inserted into an enclosure, and suited to the shape of the enclosure. It is thus possible to modularize the integration of the storage structure into an enclosure using the base, instead of having to insert it by hand. It is thus also possible to functionalize the structure thus obtained, for example by using at least one stem capable of forming a channel with resistors for modifying the temperature of the structure, or able to form a connector which impales itself in the connector at the bottom of the enclosure, or even capable of forming a tube allowing circulation of ammonia between the structure and the outside of the enclosure once the storage system is assembled. The base 60 can form a cover of the enclosure in which the structure thus formed is likely to be placed.

### Ammonia Storage Structure

Referring to FIG. 7, an ammonia storage structure is described. The structure 100 comprises at least one layer of salt 110 capable of adsorbing or absorbing ammonia. The structure 100 can consist of such a salt. Alternatively, the structure can comprise an alternation of layers of salt 110 capable of adsorbing or absorbing ammonia and of layers of heat conducting material 120.

The salt is for example a powdered salt. The powdered salt is for example selected from the alkaline earth chlorides. In particular, the powdered salt is selected from the following compounds: SrCl₂, MgCl₂, BaCl₂, CaCl₂, NaCl₂. Furthermore, storage of ammonia relies on a reversible solid-gas reaction of the type:

<Solid A>+(Gas) [symbol] <Solid B>

The salt is typically in a fixed form. Ammonia forms coordination complexes, also called ammoniacates, with alkaline earth chlorides. This phenomenon is known to those skilled in the art.

At least one layer of heat conducting material 120 of the structure 100 consists for example of a porous medium. This layer of heat conducting material 120 comprises for example a porous matrix made of expanded natural graphite. This layer of heat conducting material 120 can for example comprise or consist of at least one layer of expanded natural graphite previously compressed or pre-compressed, prior to installation in the enclosure 130, to an intermediate value between its free density and the density of the skeleton of graphite constituting it.

The structure comprises an assembly of modules as described previously and therefore has the same advantages of ease of manufacture. The modules being able to be identical or different.

### Storage System

With reference to FIG. 7, a system 1000 for storing gas by absorption or adsorption is described, comprising an enclosure 130 in which is positioned a storage structure 100 as described previously.

### Catalytic Reduction System

With reference to FIG. 8, a system for selective catalytic reduction for exhaust gases of internal combustion engine is described. The catalytic reduction system comprises a storage system 81 as described previously. The catalytic reduction system further comprises a module 82 for injecting ammonia into the exhaust gases. The storage system 81 and the injection system 82 are connected and the assembly is controlled to allow injection of the stored ammonia into the exhaust gases.

### Manufacturing Method

The invention also comprises a method for manufacturing a structure as described previously. The method comprises the assembly of a module as described previously, using the attachment means of this module, to another module as described previously. The two modules can be identical or different.

1. A module for constructing an ammonia storage structure, the structure comprising at least one layer of salt adapted to adsorb or absorb ammonia, the module comprising an attachment to be attached to at least one other module, the attachment comprising at least one of:
(a) at least one element forming a protrusion from a first surface of the module and being adapted to piercing a surface of the other module; and
(b) a part of a first surface of the module, the shape whereof is complementary to a part of a second surface of the module, the part of the first surface protruding, the part of the second surface forming a hollow area suited to accommodate the protrusion so as to maintain two modules in contact.

2. The module according to claim 1, further comprising a part made of salt adapted to adsorb or absorb the ammonia.

3. The module according to claim 1, wherein the structure comprises an alternation of layers of salt adapted to adsorb or absorb the ammonia, and of layers of heat conducting material.

4. The module according to claim 3, wherein the module comprises a part made of the heat conducting material.

5. The module according to claim 1, wherein the at least one element forming a protrusion is formed by at least one stem attached by insertion through the first surface of the module.

6. The module according to claim 5, further comprising a base having the at least one stem.

7. An assembly comprising:
at least one module and at least one other module;
the module comprising an attachment to be attached to at least one other module, the attachment comprising at least one of:
(a) at least one element forming a protrusion from a first surface of the module and being adapted to pierce a surface of the other module; and
(b) a part of a first surface of the module, the shape whereof is complementary to a part of a second surface of the module, the part of the first surface protruding, the part of the second surface forming a hollow area suited to accommodate the protrusion so as to maintain the modules in contact; and
the at least one module and the at least one other module being assembled by the attachments of at least one of the modules.

8. An ammonia storage structure comprising at least one layer of salt adapted to adsorb or absorb ammonia, further comprising the assembly according to claim 7.

9. A system for storing gas by absorption or adsorption, comprising an enclosure in which is positioned the storage structure according to claim 8.

10. A system for selective catalytic reduction for exhaust gases of internal combustion engine, further comprising the storage system according to claim 9 and a module for injecting ammonia into the exhaust gases.

11. A method for manufacturing a structure, the method comprising using an attachment of a first module to a second module, the attachment comprising at least one of:
(a) at least one element having a protrusion from a first surface of the module and being adapted to a surface of the other module; and
(b) a part of a first surface of the module, the shape whereof is complementary to a part of a second surface of the module, the part of the first surface protruding, the part of the second surface having a hollow area suited to accommodate the protrusion so as to maintain two modules in contact.
